(19) United States
(12) Patent Application Publication
(10) Pub. No.: US 2006/0035795 A1
(43) Pub. Date: Feb. 16, 2006

(54) Household products

(75) Inventors: Jonathan Warr, Paris (FR); Masakatsu Unno, Paris (FR); Catherine Regniez, Paris (FR)

Correspondence Address: SUGHRUE MION, PLLC, 2100 PENNSYLVANIA AVENUE, N.W., SUITE 800, WASHINGTON, DC, 20037, US

(73) Assignee: TAKASAGO INTERNATIONAL CORPORATION

(21) Appl. No.: 11/198,359

(22) Filed: Aug. 8, 2005

(30) Foreign Application Priority Data
Aug. 6, 2004 (FR) 04/08727
Dec. 22, 2004 (FR) 04/13710

(51) Int. Cl. C11D 3/50

(52) U.S. Cl. 510/101

(57) ABSTRACT

The invention has as its object the method of imparting odour to a household product, which comprises incorporating an alkoxybenzene represented by formula (I): 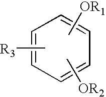 wherein
R₁ and R₂, which may be the same or different, each represents a hydrogen atom or a (C₁-C₄) alkyl group;
R₃ represents a hydrogen atom, a hydroxy group, a (C₁-C₄) alkyl group or a group of formula —OR₁, where R₁ is as defined above, or a mixture of alkoxybenzenes of formula (I); into the household product.

### FIELD OF THE INVENTION

The present invention relates to a method for imparting odour to a household product, a perfume composition used in a household product, and a household product containing the same.

### BACKGROUND OF THE INVENTION

It is normal practice to add perfumes to household products in order to make housework more pleasant or to procure a pleasant sensation for users of surfaces treated with household products or of clothes, sheets etc. cleaned with such products. Furthermore, air care products are commonly used to perfume the surrounding air.

The manufacturers of household products are faced with the need to provide consumers with products that not only show excellent cleaning performance but also give rise to a sensation of well-being and produce psychological effects in consumers, such as stimulant and/or sedative effects.

As a perfume having a sedative effect, an essential oil can be used, such as for example the essential oil of lavender, the essential oil of bergamot, the essential oil of lemon, the essential oil of marjoram, or the essential oil of sandalwood (M. Indo, Koryo No. 168, 43 (1990).

It is very important that the odoriferous (odour-providing) properties of the perfume are stable over time.

In effect, household products are not used immediately after their manufacture. Indeed, there are often consumed a few months after manufacture.

It has been found that the essential oils mentioned above lose their odoriferous properties in household products over a period of time and therefore their use in household products is of uncertain value.

Although such oils may have a satisfactory effect when the household products are used immediately after their manufacture, their odoriferous properties fade away over the course of time and sometimes the oils are even transformed with the production of an undesirable odour.

With air care products, in particular with electrically powered air care devices, diffusion is carried out in a uniform manner during a certain period of time, for example 30 to 45 days, and the ambiance-generating perfume must maintain its odoriferous note without change.

Essential oils, in particular the essential oil of lemon, are not adapted to these air care devices and an irregular loss of weight over time is observed as well as a modification as regards the odoriferous note.

With perfumed candles, the incorporation of essential oils is a difficult procedure. In effect, at the temperature of molten wax, the volatile components of the essential oils can easily evaporate, which changes the odoriferous note required. Furthermore, such candles produce a large amount of soot, which is not acceptable for the consumer.

### SUMMARY OF THE INVENTION

The inventors of the present application have therefore sought to develop perfumes that can be used in household products and which maintain their odoriferous properties over a period of time.

The inventors now found, quite surprisingly, that alkoxybenzenes of the formula (I) hereunder can be used in household products for their odoriferous properties.

In effect, it has been found that these derivatives are particularly stable in household products and that they can be easily incorporated into all types of household products, including inside air care products, and in particular candles.

Furthermore, these compounds have a sedative effect which is of particular interest at the present time in view of the stress arising from daily life which leads to various symptoms, including insomnia.

The invention therefore has as its objects

(1) a method of imparting odour to a household product, which comprises incorporating an alkoxybenzene represented by formula (I):

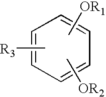

wherein

R₁ and R₂, which may be the same or different, each represents a hydrogen atom or a (C₁-C₄) alkyl group;

R₃ represents a hydrogen atom, a hydroxy group, a (C₁-C₄) alkyl group or a group of formula —OR₁, where R₁ is as defined above, or a mixture of alkoxybenzenes of formula (I);

into the household product,

(2) the method according to (1) above, wherein R₁ and R₂, which may be the same or different, each represents a methyl group or an ethyl group,

(3) the method according to (1) above, wherein the household product is other than an air care product, and the alkoxybenzene represented by formula (I) is in an amount of from 0.0001 to 0.1% by weight based on the total weight of the household product,

(4) the method according to (1) above, wherein the household product is an air care product, and the alkoxybenzene represented by formula (I) is in an amount of from 0.01 to 15% by weight based on the total weight of the household product,

(5) the method according to any one of (1) to (4) above, wherein the alkoxybenzene represented by formula (I) is 1,3,5-trimethoxybenzene, 1,3-dimethoxy-5-methylbenzene or a mixture thereof,

(6) a perfume composition, which comprises at least one alkoxybenzene represented by formula (I):

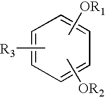

wherein

R₁ and R₂, which may be the same or different, each represents a hydrogen atom or a (C_{1-C}₄) alkyl group;

R₃ represents a hydrogen atom, a hydroxy group, a (C₁-C₄) alkyl group or a group of formula —OR₁, where R₁ is as defined above, and

a carrier which is acceptable for the perfume composition,

(7) the perfume composition according to (6) above, wherein R₁ and R₂, which may be the same or different, each represents a methyl group or an ethyl group,

(8) the perfume composition according to (6) above, which comprises 0.01 to 10% by weight of at least one alkoxybenzene represented by formula (I), based on the total weight of the perfume composition,

(9) the perfume composition according to any one of (6) to (8) above, wherein the alkoxybenzene represented by formula (I) is 1,3,5-trimethoxybenzene, 1,3-dimethoxy-5-methylbenzene or a mixture thereof,

(10) a household product, which comprises at least one alkoxybenzene represented by formula (I):

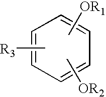

wherein

R₁ and R₂, which may be the same or different, each represents a hydrogen atom or a (C₁-C₄) alkyl group;

R₃ represents a hydrogen atom, a hydroxy group, a (C₁-C₄) alkyl group or a group of formula —OR₁, where R₁ is as defined above, and

(11) the perfume composition according to (10) above, wherein R₁ and R₂, which may be the same or different, each represents a methyl group or an ethyl group.

### DETAILED DESCRIPTION OF THE INVENTION

In the present description, “household product” is defined as product especially developed for the purpose of sanitation and cleanliness in daily life.

Specifically, in the present description, by “household products”, reference is made to products used for cleaning, polishing and disinfecting any type of surface in an area, such as a house, office, shop etc. as well as products for the treatment of clothes, sheets etc., such as washing powders and detergents, softeners etc. as well as inside deodorants which diffuse perfumes generating a particular aesthetic atmosphere (ambiance) and which are referred to as “air-care products”, such as for example candles, gels, membrane air care devices and electrically powered air-care devices optionally provided with a fan.

By “inside”, reference is made in the present description to a limited space, such as for example, the inside of a dwelling or a vehicle.

In the present application, “sedative effect” refers to psychological aspects of well-being and encompasses calming, soothing, and relaxing effects, as well as effects of stress reduction or elimination etc.

The quantity of alkoxybenzene represented by formula (I) which is appropriate for carrying out the invention varies according to the nature of the household product. Thus, for household products other than air care products, the quantity of alkoxybenzene represented by formula (I) is generally between 0.0001 and 0.1% by weight of the overall composition of the household product.

For air care products, the quantity of alkoxybenzene represented by formula (I) is generally between 0.01 and 15% by weight of the overall composition of the deodorant.

The perfume compositions for household products of the invention preferably contain 0.01 to 10% by weight of at least one alkoxybenzene of formula (I) as defined above, based on the total weight of the purfume composition.

In the compositions above, one or more than one alkoxybenzene of formula (I) may be used.

Among the alkoxybenzenes of formula (I) above, the most preferred are 1,3,5-trimethoxybenzene, 1,3-dimethoxy-5-methylbenzene and mixtures thereof.

The alkoxybenzenes represented by formula (I) which are suitable in order to carry out the invention are available from commercial sources.

They can easily be manufactured by the methods described or referred to by Wei et al, Organic Preparations and Procedures International, Vol. 35 (2003), 225, herein incorporated by reference.

The perfume compositions which can be used in carrying out the invention may be prepared by incorporating the alkoxybenzene of formula (I) to the compositions commonly used in the field of household products.

The perfume compositions containing the alkoxybenzene of formula (I) according to the invention comprise at least one alkoxybenzene of formula (I) and the other ingredient. Specifically, as the example of the perfume composition, there can be mentioned a perfume composition which comprises the alkoxybenzene of formula (I) and a carrier which is acceptable for the perfume composition.

As the examples of the carrier which is acceptable for the perfume composition, solvents which can dissolve the alkoxybenzene of formula (I), such as ethanol, isopropanol, ethylene glycol, propylene glycol, butylene glycol, pentylene glycol, hexylene glycol, dipropylene glycol and the like, can be mentioned.

Examples of the suitable perfume compositions are described in particular in patents U.S. Pat. No. 6,743,768 and GB 2 355 015, herein incorporated by reference.

Alkoxybenzenes of formula (I) can be used in all sorts of household products, including liquid, solid, etc.

In the present description, “household product” means a product which comprises at least one alkoxybenzene represented by formula (I) and an active ingredient for exerting the function as the household product. In addition, the household product may comprise a carrier or diluent which is acceptable for the household product.

As the examples of the active ingredient for exerting the function as the household product, alcohols and surfactants can be mentioned. In addition, fabric conditioner, alkaline chemicals, builder, moisturizing agents and buffer materials may be used as the active ingredient for exerting the function as the household product, depending on the kind of the household product.

Concerning household products, reference may be made to the following works:
Surfactant Science Series, Vol 71, Powdered Detergent ISBN 0-8247-9988-7,
Surfactant Science Series Vol 67 Liquid Detergents ISBN 0-8247-9391-9 (Marcel Dekker Inc),

as well as to patents or patent applications US 2003/0134769 A1; WO 2004/041983 A1; EP 0 918 835 A1 and WO 2003/022972 A1, herein incorporated by reference.

The stability of alkoxybenzenes represented by formula (I) and of essential oils in household products was determined by the test described in the illustrative examples.

The sedative effect of an alkoxybenzene represented by formula (I) according to the invention was determined by measuring the variations of negative electrical potential, called “contingent negative variations” (CNV) according to the method of Torii [Proceedings of the 19^{th} Japanese Symposium on Taste and Smell, 65 (1985)], which is also described in detail in U.S. Pat. No. 6,268,333.

Contingent negative variations are small variations in cerebral potential related to psychological processes, such as attention, waiting, anticipation etc. as well as being related to changes in the state of consciousness.

According to this method, a luminous signal is emitted approximately 2 seconds after an audible signal, and the subject must switch off the luminous signal by pressing on the button as soon as the luminous signal is recognised.

When carrying out these experiments, a sample to be tested (perfume composition) or a reference sample (with no smell) is placed around 10 centimetres from the nose of the subject taking part in these experiments in such a way as to ensure that the compound is recognised at all times via the said subject's respiration.

An electrode for measuring the contingent negative variations is placed on the subject's forehead (the reference electrode is placed on the ear lobe).

The contingent negative variations measured during an early period of time going from 400 msec to 1000 msec after the audible signal and the amplitude of these variations is expressed with respect to a reference sample to which a value of 100% is given.

A sample tested whose amplitude is greater than 100% will be a stimulant product and a sample tested with an amplitude less than 100% will be a sedative.

The measurement of contingent negative variations has shown that 1,3-dimethoxy-5-methylbenzene, trimethoxybenzene, and in particular, 1,3,5-trimethoxybenzene, had a sedative effect when used in household products comprised between 0.0001% and 0.1% by weight with respect to the total weight of the said household product.

The invention will now be described in more detail by the illustrative and non-limiting examples hereunder in which the following abbreviations have been used:
Na-LAS=sodium (linear) alkyl benzene sulfonate
Na-PAS=sodium (linear) alkyl sulfate
Na-AES=sodium alkyl ether sulfate
SCMC=sodium carboxymethylcellulose
TAED=tetraacetylethylamine
APG=alkylpolyglucoside

### EXAMPLES 1 to 7

The household products containing the ingredients mentioned in EXAMPLES 1 to 7 hereunder were prepared using mixing techniques well known to the person skilled in the art.

### Example 1

### Perfume Composition (Perfume n°1) for Powder Detergent

| Ingredient | Chemical name | CAS N^{o} | Parts per 1000 |
|---|---|---|---|
| AMBROXAN (AMBROFIX) | Dodecahydro-3a,6,6,9a-tetramethylnaphtho (2,1-b) | 6790-58-5 | 15 |
| | furan | | |
| LEVOSANDOL | 2-ethyl-4-(2,2,3-trimethyl-3-cyclopenten-1-yl)-2- | 28219-61-6 | 10 |
| | buten-1-ol | | |
| L-CITRONELLOL | 3,7-dimethyl-6-octen-1-ol | 7540-51-4 | 15 |
| COUMARIN | 1,2-benzopyrone | 91-64-5 | 5 |
| CYCLACET | Tricyclodecenyl acetate | 5413-60-5 | 30 |
| CYCLAPROP | Tricyclodecenyl propionate | 17511-60-3 | 30 |
| DIHYDRO MYRCENOL | 2,6-dimethyl-7-octen-2-ol | 18479-58-8 | 60 |
| DIPROPYLENE GLYCOL | | 25265-71-8 | 70 |
| DIMETHYL BENZYL CARBINYL | Alpha-alpha-dimethyl-phenylethyl acetate | 151-05-3 | 15 |
| ACETATE | | | |
| EXALTOLIDE TOTAL | Omega-pentadecalactone | 106-02-5 | 75 |
| GERANYL NITRILE | 3,7-dimethyl-2,6-octadiene-1-nitrile | 5146-66-7 | 5 |
| HEDIONE | Methyl dihydrojasmonate | 24851-98-7 | 115 |
| BETA IONONE | 4-(2,6,6-trimethyl-1-cyclohexen-1-yl)-3-buten-2- | 14901-07-6 | 15 |
| | one | | |
| ORBITONE | Octahydro-2,3,8,8-tetramethyl-2-acetonaphtone | 54464-57-2 | 340 |
| LINALOOL | 3,7-dimethyl-1,6-octadien-3-ol | 78-70-6 | 35 |
| MAYOL | Cis-4-(1-methylethyl)cyclohexanemethanol | 13828-37-0 | 25 |
| METHYL IONONE PURE | | 127-43-5 | 80 |
| METHYL NAPTHYL KETONE CRYSTAL | | 93-08-3 | 10 |
| NEROLIN BROMELIA | Beta-naphthyl ethyl ether | 93-18-5 | 10 |
| STYRALLYL ACETATE | α-Methylbenzyl acetate | 93-92-5 | 10 |
| 1,3,5-TRIMETHOXYBENZENE | | 621-23-8 | 10 |
| VERDOX | o-t-Butylcyclohexyl acetate | 88-41-5 | 20 |

### Example 2

### Perfume Composition (Perfume n°1) for Powder Detergent

| | | | Parts per |
|---|---|---|---|
| Ingredient | Chemical name | CAS N^{o} | 1000 |
| L-BORNEOL, CRYSTAL | Bornylic alcohol/2-Hydroxycamphane | 507-70-0 | 5 |
| L-CITRONELLOL | | 5413-60-5 | 5 |
| CYCLACET | Tricylodecenyl acetate | | 25 |
| DIHYDRO MYRCENOL | 2,6-dimethyl-7-octen-2-ol | 18479-58-8 | 255 |
| 3,5-DIMETHOXYTOLUENE | | 4179-19-5 | 5 |
| DIPROPYLENE GLYCOL | | 25265-71-8 | 45 |
| KOAVONE | Acetyl-diisoamylene | 81786-73-4 | 30 |
| LINALOOL | 3,7-dimethyl-1,6-octadien-3-ol | 78-70-6 | 5 |
| LINALYL ACETATE | 3,7-dimethyl-1,6-octadien-3-yl acetate | 115-95-7 | 15 |
| NORLIMBANOL DEXTRO | Firmenich base | 70788-30-6 | 10 |
| ORBITONE | Octahydro-2,3,8,8-tetramethyl-2-acetonaphtone | 54464-57-2 | 475 |
| PHENYL ETHYL ALCOHOL | | 60-12-8 | 125 |

### Example 3

### Perfume Compositions (Perfume n°3 and Perfume n°4) for Liquid Washing Composition

| | | | Perfume | |
|---|---|---|---|---|
| | | | n^{o} 3 parts | Perfume n^{o} 4 |
| Ingredient | Chemical name | CAS N^{o} | per 1000 | parts per 1000 |
| ALDEHYDE C - 12 MNA | | 110-41-8 | 5 | 5 |
| GAMMA UNDECALACTONE | | 104-67-6 | 5 | 5 |
| AMBER CORE | 2-t-butylcyclohexyloxy-2-butanol | 139504-68-0 | 10 | 10 |
| AMYLESALICYLATE | | 2050-08-0 | 90 | 90 |
| APHERMATE | a,3,3-trimethylcyclohexylmethyl formate | 25225-08-5 | 100 | 100 |
| LEVOSANDOL | 2-ethyl-4-(2,2,3-trimethyl-3-cyclopenten- | 28219-61-6 | 15 | 15 |
| | 1-yl)-2-buten-1-ol | | | |
| CEDRAMBER | | 19870-74-7 | 5 | 5 |
| CITRALVA | 3,7-dimethyl-2,6-octadiene-1-nitrile | 31983-27-4 | 10 | 10 |
| L-CITRONELLOL | | 7540-51-4 | 90 | 90 |
| CYCLACET | Tricyclodecenyl acetate | 5413-60-5 | 40 | 40 |
| EUGENOL | | 97-53-0 | 10 | 10 |
| DIHYDRO MYRCENOL | 2,6-dimethyl-7-octen-2-ol | 18479-58-8 | 100 | 100 |
| 3,5-DIMETHOXYTOLUENE | | 4179-19-5 | | 10 |
| DIPROPYLENE GLYCOL | | 25265-71-8 | 94 | 99 |
| GALBEX 183 | GALBEX 183 (Firmenich base) | | 2 | 2 |
| CIS-3 HEXEN-1-OL | | 928-96-1 | 2 | 2 |
| HEXYL SALICYLATE | n-Hexyl-ortho-hydroxybenzoate | 6259-76-3 | 160 | 160 |
| ALPHA-IONONE | 4-(2,2,6-trimethyl-2-cyclohexen-1-yl)-3- | 127-41-3 | 15 | 15 |
| | buten-2-one | | | |
| LINALOOL | 3,7-dimethyl-1,6-octadien-3-ol | 78-70-6 | 15 | 15 |
| ORBITONE | Octahydro-2,3,8,8-tetramethyl-2- | 54464-57-2 | 45 | 45 |
| | acetonaphthone | | | |
| PHENYL ETHYL ALCOHOL | | 60-12-8 | 15 | 15 |
| PHENYLETHYL PHENYLACETATE | | 102-20-5 | 2 | 2 |
| ROSEPHENONE | | | 10 | 10 |
| 1,3,5-TRIMETHOXYBENZENE | | 621-23-8 | 15 | |
| VERDOX | o-t-Butylcyclohexyl acetate | 88-41-5 | 110 | 110 |
| VERTOFIX COEUR | Methyl Cedryl Ketone | 32388-55-9 | 35 | 35 |

### Example 4

### Perfume Compositions (Perfumes n°5, 6 and 7) for Liquid Softener

| | | | Perfume | Perfume n° 6 | Perfume n° 7 |
|---|---|---|---|---|---|
| Ingredient | Chemical name | CAS N° | n° 5 parts per 1000 | parts per 1000 | parts per 1000 |
| GAMMA UNDECALACTONE | γ-undecalactone | 104-67-6 | 20 | 20 | 20 |
| ANISIC ALDEHYDE | p-methoxybenzaldehyde | 123-11-5 | 15 | 15 | 15 |
| BENZYL ACETATE | | 140-11-4 | 205 | 205 | 205 |
| BENZYL SALICYLATE | Benzyl-ortho-hydroxybenzoate | 118-58-1 | 15 | 15 | 15 |
| CITRONELLOL 950 | 3,7-dimethyl-6-octen-1-ol | 106-22-9 | 30 | 30 | 30 |
| COUMARIN | 1,2-benzopyrone | 91-64-5 | 20 | 20 | 20 |
| Para CRESYL METHYL ETHER | p-methyl anisole/p-methoxy toluene | 104-93-8 | 1 | 1 | 1 |
| | p-tolyl methyl ether | | | | |
| 3,5-DIMETHOXYTOLUENE | | 4179-19-5 | | 10 | 5 |
| DIPROPYLENE GLYCOL | Dipropylene glycol | 25265-71-8 | 94 | 89 | 89 |
| ETHYL VANILLIN | 3-ethoxy-4-hydroxybenzaldehyde | 121-32-4 | 60 | 60 | 60 |
| HEDIONE | Methyl dihydrojasmonate | 24851-98-7 | 170 | 170 | 170 |
| HELIOTROPIN | 3,4-methylene dioxybenzaldehyde | 120-57-0 | 15 | 15 | 15 |
| ALPHA-HEXYL- | | 101-86-0 | 15 | 15 | 15 |
| CINNAMALDEHYDE | | | | | |
| LILIAL | p-tert-butyl-alpha-methyldihydrocinnamic | 80-54-6 | 30 | 30 | 30 |
| | aldehyde | | | | |
| D-LIMONENE | | 5989-27-5 | 10 | 10 | 10 |
| LINALOOL | 3,7-dimethyl-1,6-octadien-3-ol | 78-70-6 | 100 | 100 | 100 |
| METHYL METHYL BENZOATE | | 95-58-3 | 5 | 5 | 5 |
| METHYL ISO EUGENOL | Isoeugenyl methyl ether | 93-16-3 | 5 | 5 | 5 |
| PHENYL ETHYL ALCOHOL | | 60-12-8 | 100 | 100 | 100 |
| TERPINEOL | Menth-1-en-8-ol | 98-55-5 | 50 | 50 | 50 |
| TERPINYL ACETATE | Menth-1-en-8-yl acetate | 80-26-1 | 20 | 20 | 20 |
| 1,3,5-TRIMETHOXYBENZENE | | 621-23-8 | 5 | | 5 |
| VERTOFIX COEUR | Methyl Cedryl Ketone | 32388-55-9 | 15 | 15 | 15 |

### Example 5

### Standard Powder Detergent (Standard Powder Detergents n°1 to n°3) or Concentrated Powder Detergent (Concentrated Powder n°1)

| | Standard powder | Standard powder | Standard powder | Concentrated |
|---|---|---|---|---|
| | n^{o} 1 | n^{o} 2 | n^{o} 3 | powder n^{o} 1 |
| NA-LAS | 8.5 | 11 | 11 | 8 |
| NA-PAS | | | 3.5 | 5.5 |
| NA-AES | | | | 1.5 |
| NONIONIC 7EO | 6.5 | 3.5 | 3.5 | 5 |
| CATIONIC | | | | 1.3 |
| SOAP | 2 | 1 | 1.2 | 0.3 |
| ZEOLITE A24 | 19.5 | | | |
| ZEOLITE A4 | | 22 | 3.5 | 20 |
| COPOLYMER CP5 | 1.7 | 3 | | 1 |
| POLYACRYLATE (PM 5000) | | | 3.5 | |
| NA CITRATE/CITRIC ACID | 2.5 | | 1.5 | 4 |
| NA SILICATE | 1.5 | | | |
| NA DISILICATE (SKS-6) | | 2.5 | 3.5 | 11 |
| NA CARBONATE | 18.5 | 18.5 | 26.5 | 14 |
| NA SULPHATE | 27.5 | 10 | 21 | 4 |
| SCMC | 0.15 | | | 0.15 |
| TAED (83% MA) | 1 | 4 | 3.5 | 5 |
| NA PERCARBONATE | 7 | | 13 | 13 |
| NA PERBORATE | | 19 | | |
| PERFUME 1 | 0.35 | | | 0.55 |
| PERFUME 2 | | 0.4 | 0.4 | |
| ANTI-FOAMING AGENT (15% MA) | 1 | 0.7 | 0.7 | 1 |
| FLUORESCENCE AGENT (15% MA) | 1 | 0.7 | 0.7 | 0.7 |
| DEFLOCULATING AND SEQUESTRATING AGENT | 0.8 | 0.8 | 1.5 | 1.5 |
| (DEQUEST ® 2047 AND 2016) | | | | |
| ENZYMES (PROTEASE, LIPASE, CELLULASE, AMYLASE) | 0.3 | 1 | 1 | 1.5 |
| COLOURED CARBONATE | | 1.5 | | |
| POLYMERS FOR FABRIC MAINTENANCE (ELIMINATION | 0.2 | 0.4 | 0.5 | 1 |
| OF STAINS, DYE TRANSFER, ETC.) | | | | |
| TOTAL | 100 | 100 | 100 | 100 |

### Example 6

### Standard Liquid Detergent (St. Liq. n°1 to n°4) or Concentrated Liquid Detergent (Conc. Liq. n°1 to n°4)

| | St Liq 1 | St Liq 2 | St Liq 3 | St Liq 4 | Conc Liq 1 | Conc Liq 2 | Conc Liq 3 | Conc Liq 4 |
|---|---|---|---|---|---|---|---|---|
| NA-LAS | 9.5 | | | | 14 | | | |
| NA-PAS | | 4 | 10 | 7 | 4 | 5 | 5 | 15 |
| NA-AES | | | 2 | 2 | | | | 2.6 |
| NONIONIC 7EO | 15 | 9 | 3.5 | 4.5 | 15 | 24 | 22 | 5 |
| CATIONIC | | | 1 | | | | | 2 |
| SOAP | 15 | 15 | 7 | 6 | 12 | 17 | 18 | 11 |
| APG | | 4 | | | | 4 | 2.5 | |
| GLUCOSAMIDE | | | 4.5 | 4 | | | | 6 |
| MONO ETHANOL AMINE | | | 5 | 3.5 | | | | 6.5 |
| CITRATE | 1 | 1 | 2 | 1.2 | 6 | 1 | 4 | 2 |
| PROPYLENE GLYCOL | | 3 | 6 | 6 | 5 | | 3 | 8 |
| GLYCEROL | | | | | | 4 | | |
| ETHANOL/IMS (INDUSTRIAL | 7 | 2 | 1 | 1 | | 7 | 1.5 | 2.2 |
| ALCOHOLS) | | | | | | | | |
| PERFUME N° 3 | 0.4 | | 0.5 | | 0.6 | | 0.7 | |
| PERFUME N° 4 | | 0.4 | | 0.4 | | 0.7 | | 0.7 |
| ANTI-FOAMING AGENT | 1 | 0.7 | 0.7 | 0.7 | 1 | 1 | 1 | 1 |
| (15% MA) | | | | | | | | |
| FLUORESCENCE AGENT | 1.1 | 0.7 | 0.7 | 0.7 | 1 | 1 | 1 | 1 |
| (15% MA) | | | | | | | | |
| DEFLOCULATING AND | 1 | 1 | 1.4 | 1 | 1.5 | 1.5 | 1.5 | 1.5 |
| SEQUESTRATING AGENT | | | | | | | | |
| (DEQUEST ® 2040 AND | | | | | | | | |
| 2010) | | | | | | | | |
| ENZYMES (PROTEASE, | 0.7 | 1.05 | 1.05 | 0.9 | 1.2 | 1.2 | 1.2 | 1.2 |
| LIPASE, CELLULASE, | | | | | | | | |
| AMYLASE) | | | | | | | | |
| POLYMERS FOR FABRIC | 1 | 1 | 1 | 1 | 1.5 | 1.5 | 1.5 | 1.5 |
| MAINTENANCE | | | | | | | | |
| (ELIMINATION OF STAINS, | | | | | | | | |
| DYE TRANSFER, ETC.) | | | | | | | | |
| WATER | 47.3 | 57.15 | 52.65 | 60.1 | 37.2 | 31.1 | 37.1 | 32.8 |
| TOTAL | 100 | 100 | 100 | 100 | 100 | 100 | 100 | 100 |

### Example 7

### Standard Softener (St FC 1) or Concentrated Liquid Softener (Conc FC 1-2)

| | St FC 1 | Conc FC 1 | Conc FC 2 |
|---|---|---|---|
| TETRANYL AHT-1 | 5.0 | 12.0 | |
| DEQA | | | 18 |
| GENAPOL C200 | 0.1 | 0.75 | 3 |
| ISOPROPYL ALCOHOL | | | 3 |
| POLYETHYLENE GLYCOL 4000 | | | 0.6 |
| LAUREX CS | 0.4 | 1.8 | |
| PERFUME N^{o} 5 | 0.3 | | |
| PERFUME N^{o} 6 | | 0.9 | |
| PERFUME N^{o} 7 | | | 0.7 |
| DYE, ANTIFOAMING AGENT, | qs | qs | Qs |
| PRESERVATIVE | | | |
| MAGNESIUM CHLORIDE | qs | qs | Qs |
| WATER QSP | 100 | 100 | 100 |

Tetranyl AHT-1; semi-hard tallow ester of triethanolammonium methosulphate, marketed by Kao Corp
Genapol C200; copra ethoxylate, marketed by Clariant
Laurex CS; Long chain alcohol, marketed by Albright & Wilson
DEQA; soft di(tallow oxyethyl) dimethylammonium chloride

### EXAMPLE 8

### Determination of Stability

0.15% by weight of 1,3,5-trimethoxybenzene (TMB) or of 1,3-dimethoxy-5-methylbenzene (DMB) or of an essential oil were mixed in a commercial detergent preparation not containing any perfume known under the trade name “PERSIL SENSITIV” marketed in Germany by Henkel.

The essential components of this detergent are:

| | |
|---|---|
| Less than 5% | Phosphonate, soap, nonionic surfactant, polycarboxylate |
| 15 to 30% | Bleaching agent, anionic surfactant, zeolite (SASIL ®) |
| | Enzyme (Amylase, Cellulase, Protease) |
| | TAED, Soda, sodium citrate, optical brightener |

Samples of this detergent were stored in cardboard packaging sold by the company Gandolphe Emballages Sarl at 40° C. with 70% relative humidity.

Stability was judged by a perfume specialist according to the following scale of values 1-5:

1—stable (no modification)

2—stable (no modification, but loss of the leading note observed)

3—acceptable (very slightly modified)

4—borderline (slightly modified)

5—unstable (modified and bad).

The essential oils known for their relaxing effects were stored as indicated above and their odoriferous properties were judged after five weeks of storage and compared to those of TMB or DMB stored in the same conditions.

The results gathered together in the table below clearly show that the essential oils are unstable whereas DMB and TMB are stable.

| Essential oils | stability |
|---|---|
| Essence of bergamot | 5 |
| Essence of camomile | 4 |
| Essence of lemon | 5 |
| Essence of marjoram | 4 |
| Essence of sandalwood | 4 |
| Essence of lavender | 5 |
| TMB (used in the form of a 25% solution in dipropylene | 2 |
| glycol) | |
| DMB | 2 |

### EXAMPLE 9

### Perfume Composition for Electrically Powered Air Care Devices

| | | | Parts per |
|---|---|---|---|
| Ingredient | Chemical name | CAS N^{o} | 1000 |
| HEDIONE | Methyl dihydrojasmonate | 24851-98-7 | 120 |
| 1,3,5-TRIMETHOXYBENZENE | | 621-23-8 | 100 |
| ORBITONE | Octahydro-2,3,8,8-tetramethyl-2-acetonaphtone | 54464-57-2 | 100 |
| DI-HYDRO MYRCENOL | 2,6-dimethyl-7-octen-2-ol | 18479-58-8 | 40 |
| MUSK-T | 1,4-Dioxacycloheptadecane-5,17-dione | 105-95-3 | 40 |
| LEVOSANDOL | 2-ethyl-4-(2,2,3-trimethyl-3-cyclopenten-1-yl)-2- | 28219-61-6 | 8 |
| | buten-1-ol | | |
| CITRAL | 3,7-dimethyl-2,6-octadienal (mixture of cis and | 5392-40-5 | 5 |
| | trans) | | |
| ISO BUTYL QUINOLINE (1% IN DPG) | 6-(1-Methylpropyl)quinoline | 65442-31-1 | 2 |
| ALLYL CYCLOHEXYL PROP | Allyl cyclohexanepropionate | 2705-87-5 | 1 |
| AMBROXAN | Dodecahydro-3a,6,6,9a-tetramethylnaphtho- | 3738-00-9 | 1 |
| | (2,1-b)-furane | | |
| AMBRETONE | 5-cyclohexadecen-1-one | 37609-25-9 | 1 |
| HEXENYL ACETATE, CIS-3 | | 3681-71-8 | 0.5 |
| ETHYL 2-METHYLBUTYRATE | | 7452-79-1 | 0.5 |

The perfume composition of EXAMPLE 9 can be used in devices for the diffusion of ambiance-generating perfumes, which are available from commercial sources, such as those known under the trade names “Glade® Plug-In”, “Glade® Wisp”, “Reckitt-Benckiser Air-Wick® Mobil”, “Air-Wick®”, “Ambi-Pur Car®” and “Sara Lee Inspira®”. This composition can advantageously be added to these devices in a volatile solvent (ester, ether etc.), such as for example a glycol ether solvent of the “Dowanol” range (for example Dowanol DPNB or Dowanol DPM—Dow Chemical) in order to modulate the number of days of evaporation.

The perfume compositions can also be added to these devices in the form of a gel obtained by mixing the said perfume composition as illustrated in EXAMPLE 10.

### EXAMPLE 10

### Perfume Composition in the Form of a Gel for a Membrane Air Care Device or an Electrically Powered Air Care Device

40% of the perfume composition of EXAMPLE 9 were mixed with 55.97% of Dowanol DPM, 4% of the hydrophilic silica known under the trade name “Cab-O-Sil”® (Cabot GmbH) and 0.03% of Tween 20.

### EXAMPLE 11

### Perfuming Oil or Candle

A perfuming oil for a candle was prepared by mixing the ingredients shown in the table below.

### EXAMPLE 12

### Perfuming Candle

A perfuming candle was prepared by melting the wax and the other ingredients in a water bath at 80° C. and then adding the perfuming oil according to EXAMPLE 11 and mixing until a uniform mixture was obtained, which was then flowed into a mould with a wick.

The candle thus formed was then left to cool down for 24 hours. This candle was then burnt so as to diffuse the perfume composition in a stable way during at least 24-36 hours.

### EXAMPLE 11

### Perfuming Oil for Candle

| | | | Parts per |
|---|---|---|---|
| Ingredient | Chemical name | CAS N^{o} | 1000 |
| HEDIONE | Methyl dihydrojasmonate | 24851-98-7 | 250 |
| LINALOOL | 3,7-dimethyl-1,6-octadien-3-ol | 78-70-6 | 150 |
| MUSK-T | 1,4-Dioxacycloheptadecane-5,17-dione | 105-95-3 | 100 |
| VERTENEX | 4-(1,1-dimethylethyl)cyclohexanol acetate | 32210-23-4 | 100 |
| DI-HYDRO MYRCENOL | 2,6-dimethyl-7-octen-2-ol | 18479-58-8 | 60 |
| VERDOX | o-t-Butylcyclohexyl acetate | 88-41-5 | 50 |
| 1,3,5-TRIMETHOXYBENZENE | | 621-23-8 | 35 |
| CITRAL | 3,7-dimethyl-2,6-octadienal (mixture of cis et | 5392-40-5 | 25 |
| | trans) | | |
| ALLYL CYCLOHEXYL PROP | Allyl cyclohexyl-3 propionate | 2705-87-5 | 20 |
| CITRONELLYL NITRILE, L | (3R)-3,7-dimethyloct-6-enenitrile | 51566-62-2 | 20 |
| LEVOSANDOL | 2-ethyl-4-(2,2,3-trimethyl-3-cyclopenten-1-yl)-2- | 28219-61-6 | 10 |
| | buten-1-ol | | |
| ORBITONE | Octahydro-2,3,8,8-tetramethyl-2- | 54464-57-2 | 20 |
| | acetonaphthone | | |
| AMBROXAN | Dodecahydro-3a,6,6,9a-tetramethylnaphtho | 3738-00-9 | 2 |
| | (2,1-b) furane | | |
| DIMETHYL BENZYL CARBINYL BUTYRATE | | 10094-34-5 | 2 |
| ETHYL 2-METHYLBUTYRATE | | 7452-79-1 | 1 |
| CLONAL | 1-cyanoundecane | 2437-25-4 | 1 |
| ETH VANILLIN | 3-ethoxy-4-hydroxybenzaldehyde | 121-32-4 | 1 |

### EXAMPLE 12

### Perfuming Candle

| | PARTS |
|---|---|
| NAME | PER 100 |
| PARAFFIN WAX 52.54 (AIGLON SA) | 22 |
| STEARIC ACID PRISTERENE 9559 (UNIQUIMA) | 20 |
| BEESWAX, CEREWAX A.75 (BAERLOCHER FRANCE) | 8 |
| WHITE VASELINE (AIGLON SA) | 16 |
| LIQUID PARAFFIN (AIGLON SA) | 24 |
| PERFUME COMPOSITION OF EXAMPLE 11 | 10 |

This application is based on French patent application No. 04/08727 filed on Aug. 6, 2004 and French patent application No. 04/13710 filed on Dec. 22, 2004, the entire contents thereof being hereby incorporated by reference.

What is claimed is:

1. A method of imparting odour to a household product, which comprises incorporating an alkoxybenzene represented by formula (I): 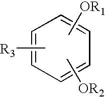
wherein
R¹ and R₂, which may be the same or different, each represents a hydrogen atom or a (C₁-C₄) alkyl group;
R₃ represents a hydrogen atom, a hydroxy group, a (C₁-C₄) alkyl group or a group of formula —OR₁, where R₁ is as defined above, or a mixture of alkoxybenzenes of formula (I);
into the household product.

2. The method according to claim 1, wherein R₁ and R₂, which may be the same or different, each represents a methyl group or an ethyl group.

3. The method according to claim 1, wherein the household product is other than an air care product, and the alkoxybenzene represented by formula (I) is in an amount of from 0.0001 to 0.1% by weight based on the total weight of the household product.

4. The method according to claim 1, wherein the household product is an air care product, and the alkoxybenzene represented by formula (I) is in an amount of from 0.01 to 15% by weight based on the total weight of the household product.

5. The method according to any one of claims 1 to 4, wherein the alkoxybenzene represented by formula (I) is 1,3,5-trimethoxybenzene, 1,3-dimethoxy-5-methylbenzene or a mixture thereof.

6. A perfume composition, which comprises at least one alkoxybenzene represented by formula (I): 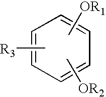
wherein
R₁ and R₂, which may be the same or different, each represents a hydrogen atom or a (C₁-C₄) alkyl group;
R₃ represents a hydrogen atom, a hydroxy group, a (C₁-C₄) alkyl group or a group of formula —OR₁, where R₁ is as defined above, and a carrier which is acceptable for the perfume composition.

7. The perfume composition according to claim 6, wherein R₁ and R₂, which may be the same or different, each represents a methyl group or an ethyl group.

8. The perfume composition according to claim 6, which comprises 0.01 to 10% by weight of at least one alkoxybenzene represented by formula (I), based on the total weight of the perfume composition.

9. The perfume composition according to any one of claims 6 to 8, wherein the alkoxybenzene represented by formula (I) is 1,3,5-trimethoxybenzene, 1,3-dimethoxy-5-methylbenzene or a mixture thereof.

10. A household product, which comprises at least one alkoxybenzene represented by formula (I): 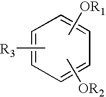
wherein
R₁ and R₂, which may be the same or different, each represents a hydrogen atom or a (C₁-C₄) alkyl group;
R₃ represents a hydrogen atom, a hydroxy group, a (C₁-C₄) alkyl group or a group of formula —OR₁, where R₁ is as defined above.

11. The household product according to claim 10, wherein R₁ and R₂, which may be the same or different, each represents a methyl group or an ethyl group.
